(19) United States
(12) Patent Application Publication
(10) Pub. No.: US 2010/0136305 A1
(43) Pub. Date: Jun. 3, 2010

(54) METHOD FOR MANUFACTURING PHOSPHORESCENT PLATE, AND PHOSPHORESCENT PLATES

(76) Inventor: Yasuhiro Sakai, Fukui (JP)

Correspondence Address: FLYNN THIEL BOUTELL & TANIS, P.C., 2026 RAMBLING ROAD, KALAMAZOO, MI, 49008-1631, US

(21) Appl. No.: 12/312,134

(22) PCT Filed: Oct. 11, 2007
(86) PCT No.: PCT/JP2007/069803

§ 371 Date: Jan. 12, 2010

(30) Foreign Application Priority Data
Oct. 25, 2006 (JP) 2006-290038
Jun. 26, 2007 (JP) 2007-168001

(51) Int. Cl. B32B 3/10; B05D 5/06; B32B 17/06

(52) U.S. Cl. 428/207; 427/157; 428/426

(57) ABSTRACT

[PROBLEMS] To provide a method for manufacturing a phosphorescent plate which generates phosphorescence having sufficient luminance and has improved phosphorescent properties, and to provide the phosphorescent plate.

[MEANS FOR SOLVING PROBLEMS] A method for manufacturing a phosphorescent plate (100) includes a first-dot forming step of forming first dots by applying a first liquid mixture containing a glass frit, a phosphorescent material, and a resin to one surface of a substrate (10) in dot form; a sprinkling step of forming a first-dot layer (21) by sprinkling a phosphorescent material on surfaces of the first dots and drying the phosphorescent material; a coating step of coating a surface of the first-dot layer (21) with a second liquid mixture containing a glass frit, a phosphorescent material, and a resin and forming a coating layer (22); and a first firing step of forming a phosphorescent layer (20) by firing the first-dot layer and the coating layer (22).

### TECHNICAL FIELD

The present invention relates to a method for manufacturing a phosphorescent plate, and the phosphorescent plate.

### BACKGROUND ART

Phosphorescent plates, which have a phosphorescent function, are mainly used as phosphorescent guide signs at sidewalks, hospitals, public facilities, and the like. Such phosphorescent plates need to have sufficient illuminance according to the places in which they are installed, and particularly, sufficient visibility in dark places is required.

Meanwhile, as an example of such phosphorescent plates, a fired product having a phosphorescent function in which a plurality of layers of a glass frit, a plurality of layers of a phosphorescent material having a large particle diameter, and an image layer are laminated on a surface of a ceramic material is disclosed (see, for example, Patent Document 1).

According to this method, by laminating a plurality of layers of a phosphorescent material, it is possible to improve afterglow luminance (phosphorescent properties) to some degree.
Patent Document 1: Japanese Unexamined Patent Application Publication No. 2006-219317

### DISCLOSURE OF INVENTION

### Problems to be Solved by the Invention

However, in the fired product described in Patent Document 1 above, the luminance of the phosphorescence tends to be insufficient, depending on the place in which it is installed. That is, when installed in a dark place, for example, the fired product described in Patent Document 1 may not function sufficiently as a guide sign since it does not generate phosphorescence having sufficient luminance.

Since it has been required that phosphorescent plates are installed in a wide variety of places in recent years, further improvement of luminance is required.

The present invention has been made in view of the above circumstances, and an object thereof is to provide a method for manufacturing a phosphorescent plate which generates phosphorescence having sufficient luminance and has improved phosphorescent properties, and to provide the phosphorescent plate.

### Means for Solving the Problems

The present inventors, as a result of diligent studies to solve the above problems, have found that the above problems can be solved by providing a phosphorescent layer by forming dots containing a phosphorescent material and forming dots containing a phosphorescent material on a surface of the phosphorescent layer again and have accomplished the present invention.

That is, the present invention resides in (1) a method for manufacturing a phosphorescent plate, comprising: a first-dot forming step of forming first dots by applying a first liquid mixture containing a glass frit, a phosphorescent material, and a resin to one surface of a substrate in dot form; a sprinkling step of forming a first-dot layer by sprinkling a phosphorescent material on surfaces of the first dots and drying the phosphorescent material; a coating step of coating a surface of the first-dot layer with a second liquid mixture containing a glass frit, a phosphorescent material, and a resin and forming a coating layer; and a first firing step of forming a phosphorescent layer by firing the first-dot layer and the coating layer.

The present invention resides in (2) the method for manufacturing a phosphorescent plate according to (1) above, further comprising: a second-dot forming step of forming second dots by applying a third liquid mixture containing a glass frit, a phosphorescent material, and a resin to a surface of the phosphorescent layer in dot form; and a second firing step of firing the second dots.

The present invention resides in (3) the method for manufacturing a phosphorescent plate according to (1) above, further comprising: an image layer forming step of forming an image layer by coating a surface of the phosphorescent layer with a printing liquid containing a glass frit and an inorganic pigment.

The present invention resides in (4) the method for manufacturing a phosphorescent plate according to (2) above, further comprising: a surface layer forming step of forming a surface layer having a smooth surface by applying a treatment liquid containing a glass fit to surfaces of the second dots; and a third firing step of firing the surface layer.

The present invention resides in (5) the method for manufacturing a phosphorescent plate according to (1) above, further comprising, prior to the first-dot forming step: a blasting step of blasting at least one surface of a steel plate and converting the surface into a rough surface; and a substrate forming step of providing a substrate by applying an enamel glaze containing a white pigment to the rough surface and firing the enamel glaze.

The present invention resides in (6) a phosphorescent plate obtained by a manufacturing method according to any one of (1) to (5) above.

The present invention resides in (7) a phosphorescent plate, comprising: a substrate; a phosphorescent layer formed on one surface of the substrate and containing a glass frit, a phosphorescent material, and a resin; and dots formed on a surface of the phosphorescent layer and containing a glass fit, a phosphorescent material, and a resin.

The present invention resides in (8) the phosphorescent plate according to (7) above, further comprising: an image layer formed on a surface of the phosphorescent layer in an area other than the dots and containing a glass frit and an inorganic pigment.

The present invention resides in (9) the phosphorescent plate according to (7) above, further comprising: a surface layer formed on surfaces of the dots and containing a glass fit.

The present invention resides in (10) the phosphorescent plate according to (7) above, wherein the substrate comprises: a steel plate; and a glaze layer comprising an enamel glaze formed on at least one side of the steel plate.

The present invention resides in (11) the phosphorescent plate according to (7) above, wherein a fitting device is mounted on a surface of the substrate opposite from the phosphorescent layer.

Any appropriate combination of (1) to (5) or (7) to (11) above can be also employed as long as it meets the objects of the present invention.

### Advantageous Effects of the Invention

In the method for manufacturing a phosphorescent plate of the present invention, a phosphorescent plate having a sufficient amount of phosphorescent material is obtained since the phosphorescent layer is formed by a first-dot forming step of forming first dots containing a phosphorescent material; a sprinkling step of sprinkling a phosphorescent material; a coating step of coating a second liquid mixture containing a phosphorescent material; and a first firing step of firing these.

That is, since the above method for manufacturing a phosphorescent plate comprises a first-dot forming step, a phosphorescent layer having a sufficient thickness is formed easily, without lamination being repeated.

Accordingly, according to the above method for manufacturing a phosphorescent plate, a phosphorescent plate which generates phosphorescence having sufficient luminance and has sufficiently improved phosphorescent properties is obtained.

Here, the term “phosphorescent properties” refers to the properties of storing the light energy of a fluorescent lamp or the sun's rays and retaining afterglow in a dark place.

Moreover, according to the above method for manufacturing a phosphorescent plate, since a glass frit is used, a phosphorescent plate having sufficient water resistance and chemical resistance is obtained.

Accordingly, the phosphorescent plate obtained by the above method for manufacturing a phosphorescent plate can be installed and used for a long period of time on a sidewalk or the like as a phosphorescent guide sign.

In the above method for manufacturing a phosphorescent plate, when second dots containing a phosphorescent material are further formed on a surface of the phosphorescent layer by a second-dot forming step, a phosphorescent plate having a more sufficient amount of phosphorescent material is obtained.

Accordingly, according to the above method for manufacturing a phosphorescent plate, a phosphorescent plate having more sufficiently improved phosphorescent properties is obtained.

Moreover, in the above method for manufacturing a phosphorescent plate, since the second dots formed on a surface of the phosphorescent layer exhibit a light-collecting effect, a phosphorescent plate which generates phosphorescence having further improved luminance is obtained.

Further, according to the above method for manufacturing a phosphorescent plate, since second dots are formed on a surface of the phosphorescent layer, a phosphorescent plate also having excellent wear resistance is obtained.

Accordingly, the phosphorescent plate obtained by the above method for manufacturing a phosphorescent plate is less slippery for those walking on the phosphorescent plate when installed on a sidewalk as a phosphorescent guide sign.

In the above method for manufacturing a phosphorescent plate, when the method further comprises: an image layer forming step of forming an image layer; and a second-dot forming step of forming second dots on a surface of the phosphorescent layer in an area other than the image layer, it is possible to illuminate a predetermined character and/or pattern expressed on the image layer by means of the phosphorescence of the phosphorescent material.

In this case, the obtained phosphorescent plate is suitably used as a phosphorescent guide sign for the purpose of conveying a message.

Therefore, in this case, the obtained phosphorescent plate is more suitably used as a phosphorescent guide sign for the purpose of conveying a message.

In the above method for manufacturing a phosphorescent plate, when the method further comprises: a surface layer forming step of forming a surface layer having a smooth surface; and a third firing step of firing the surface layer, the surface of the obtained phosphorescent plate is smooth and therefore resistant to soiling.

That is, the phosphorescent plate obtained by the above method for manufacturing a phosphorescent plate is resistant to soiling even when installed and used for a long period of time on a sidewalk or the like as a phosphorescent guide sign.

In the above method for manufacturing a phosphorescent plate, when a substrate is manufactured from a steel plate through a blasting step and a substrate forming step, the obtained phosphorescent plate has more excellent water resistance and chemical resistance.

When obtained by the above-described method for manufacturing a phosphorescent plate, the phosphorescent plate of the present invention has phosphorescence having sufficient luminance and improved phosphorescent properties.

The phosphorescent plate of the present invention generates phosphorescence having sufficient luminance and has improved phosphorescent properties since it comprises: a substrate; a phosphorescent layer formed on one surface of the substrate and containing a glass frit, a phosphorescent material, and a resin; and dots formed on a surface of the phosphorescent layer and containing a glass frit, a phosphorescent material, and a resin.

That is, in the above phosphorescent plate, since dots are formed on a surface of the phosphorescent layer, the dots exhibit a light-collecting effect and improve the luminance of the phosphorescence generated.

Therefore, such a phosphorescent plate has sufficient visibility even when installed in a dark place.

Moreover, the above phosphorescent plate also has excellent wear resistance since dots are formed on a surface of the phosphorescent layer.

Accordingly, the above phosphorescent plate has an advantage that it is less slippery for those walking on the phosphorescent plate when installed on a sidewalk as a phosphorescent guide sign.

For these reasons, according to the above phosphorescent plate, phosphorescence having sufficient luminance is generated and phosphorescent properties are improved.

When the above phosphorescent plate further comprises an image layer, it is possible to express a predetermined character and/or pattern on the image layer and illuminate these by means of a phosphorescent material. Therefore, in this case, the above phosphorescent plate is suitably used as a phosphorescent guide sign for the purpose of conveying a message.

The above phosphorescent plate is resistant to soiling when it further comprises a surface layer on surfaces of the dots or the image layer.

That is, the phosphorescent plate obtained by the above method for manufacturing a phosphorescent plate can be used for a long period of time and is resistant to soiling when installed on a sidewalk as a phosphorescent guide sign.

The phosphorescent plate of the present invention has more excellent water resistance and chemical resistance and can be used for a long period of time more surely when the substrate comprises: a steel plate; and a glaze layer comprising an enamel glaze formed on at least one side of the steel plate.

The phosphorescent plate of the present invention can be easily installed on the ground, a wall, or the like when a fitting device is mounted on a surface of the substrate opposite from the phosphorescent layer.

### BEST MODE FOR CARRYING OUT THE INVENTION

Preferred embodiments of the present invention will be described in detail below with reference to the drawings as necessary. In the drawings, the same elements are denoted by the same reference numerals, and their overlapping explanations are omitted. Moreover, the dimensional proportions of the drawings do not limit the present invention to the shown proportions.

### First Embodiment

First, a first embodiment of the phosphorescent plate of the present invention will be described.

FIG. 1 is a sectional view schematically showing a first embodiment of the phosphorescent plate according to the present invention.

As shown in FIG. 1, the phosphorescent plate 100 according to this embodiment comprises: a substrate 10; a phosphorescent layer 20 formed on one surface of the substrate 10 and containing a glass frit, a phosphorescent material, and a resin; and an image layer 40 formed on a surface of the phosphorescent layer 20 and containing a glass frit and an inorganic pigment.

That is, the phosphorescent plate 100 according to this embodiment has a construction in which the phosphorescent layer 20 is laminated on the substrate 10, and the image layer 40 is laminated on the phosphorescent layer 20.

In the phosphorescent layer 20, preferably, the mixing ratio of the glass frit is 20 to 50% by mass of the total mass of the phosphorescent layer 20, the mixing ratio of the phosphorescent material is 20 to 50% by mass of the total mass of the phosphorescent layer 20, and the mixing ratio of the resin is 20 to 50% by mass of the total mass of the phosphorescent layer 20.

The phosphorescent plate 100 in this case has excellent strength and luminance.

The thickness of the phosphorescent layer 20 is preferably 600 to 1000 μM.

When the thickness is less than 600 μm, the phosphorescent properties tend to be insufficient, compared with the case where the thickness is in the above range, and, when the thickness is more than 1000 μm, light tends to enter the phosphorescent plate 100 insufficiently, compared with the case where the thickness is in the above range.

In the image layer 40, the mixing ratio of the glass frit and the inorganic pigment is preferably 1.5:1 to 4:1 in terms of mass ratio.

In this case, there are advantages that color can be sufficiently developed and the image layer 40 is resistant to wear.

The phosphorescent plate 100 according to this embodiment generates phosphorescence having sufficient luminance and has sufficiently improved phosphorescent properties since it has a sufficient amount of phosphorescent material.

Moreover, the above phosphorescent plate 100 has sufficient water resistance and chemical resistance since a glass frit is used.

Accordingly, the above phosphorescent plate 100 can be installed and used for a long period of time on a sidewalk or the like as a phosphorescent guide sign.

The method for manufacturing the phosphorescent plate 100 according to the first embodiment will be described below.

FIGS. 2(a), (b), (c), (d) and (e) show a flow chart schematically showing manufacturing steps of the phosphorescent plate according to this embodiment.

As shown in FIGS. 2(a), (b), (c), (d) and (e), the method for manufacturing the phosphorescent plate 100 according to this embodiment comprises: a first-dot forming step of forming dots (hereinafter referred to as “first dots” for convenience) by applying a first liquid mixture containing a glass frit, a phosphorescent material, and a resin to one surface of the substrate 10 in dot form; a sprinkling step of forming a first-dot layer 21 by sprinkling a phosphorescent material on surfaces of the first dots and drying the phosphorescent material; a coating step of coating a surface of the first-dot layer 21 with a second liquid mixture containing a glass frit, a phosphorescent material, and a resin and forming a coating layer 22; a first firing step of forming a phosphorescent layer 20 by firing the first-dot layer 21 and the coating layer 22; and an image layer forming step of forming an image layer 40 by coating a surface of the phosphorescent layer 20 with a printing liquid containing a glass frit and an inorganic pigment.

(First-Dot Forming Step)

The first-dot forming step is a step of forming first dots by applying a first liquid mixture containing a glass frit, a phosphorescent material, and a resin to one surface of the substrate 10 in dot form, as shown in FIG. 2(a).

In the method for manufacturing the phosphorescent plate 100 according to this embodiment, since the method comprises a first-dot forming step, a phosphorescent layer 20 having a sufficient thickness can be formed easily, without lamination being repeated.

Accordingly, in this case, a phosphorescent plate 100 having improved phosphorescent properties is obtained.

Examples of the substrate 10 include steel plates, such as iron plates, stainless-steel plates, aluminum plates, and ceramic plates; porcelain; and stoneware.

As will be described later, the above steel plates may comprise glaze layers comprising an enamel glaze on both surfaces thereof.

In the first liquid mixture, the glass frit functions as an adhesive binding the phosphorescent material.

As such a glass frit, a lead-free glass frit is suitably used. Examples of such a lead-free glass frit include borosilicate glass fits, soda-lime glass frits, and aluminosilicate glass fits which are free of lead and cadmium.

These glass fits may be used alone, or a plurality of them may be used as a mixture.

The phosphorescent material is typically a powder and is an inorganic phosphor which emits fluorescence by means of ultraviolet irradiation. Accordingly, such a phosphorescent material plays the functions of storing the light energy of a fluorescent lamp or the sun's rays and emitting afterglow in a dark place.

Examples of such an inorganic phosphor include strontium aluminate or calcium aluminate doped with europium or dysprosium as an activator, and zinc oxide doped with copper or cobalt as an activator.

These inorganic phosphors may be used alone, or a plurality of them may be used as a mixture.

The resin exhibits the function of uniformly dispersing the phosphorescent material in the phosphorescent layer 20.

Examples of such a resin include acrylic resins, carboxymethyl cellulose, methyl cellulose, ethyl cellulose, butyral resins, urethane resins, and polyamide resins.

These resins may be used alone, or a plurality of them may be used as a mixture.

In the first-dot forming step, first dots are preferably formed to have a thickness of 300 to 500 μm.

When the thickness is less than 300 μm, the phosphorescent properties tend to be insufficient, compared with the case where the thickness is in the above range, and, when the thickness is more than 500 μm, there is a danger of tripping over the phosphorescent plate 100 when the phosphorescent plate 100 is installed on the ground, for example, compared with the case where the thickness is in the above range.

In the first liquid mixture, preferably, the mixing ratio of the glass frit is 20 to 50% by mass of the total mass of the first liquid mixture, the mixing ratio of the phosphorescent material is 20 to 50% by mass of the total mass of the first liquid mixture, and the mixing ratio of the resin is 20 to 50% by mass of the total mass of the first liquid mixture.

In this case, the phosphorescent material sprinkled in the sprinkling step, which will be described later, mixes with the first liquid mixture sufficiently.

Examples of the method of applying the first liquid mixture to the substrate 10 include dot screen coating and dot transfer.

Of these, dot screen coating is preferable, and more preferably, the screen to be used has a thickness of 0.3 to 0.5 mm and a mesh size of 80 to 120.

The first liquid mixture may contain additives, such as viscosity modifiers, pH adjusters, preservatives, and fillers.

(Sprinkling Step)

The sprinkling step is a step of forming a first-dot layer 21 by sprinkling a phosphorescent material on surfaces of the first dots formed in the first-dot forming step and drying the phosphorescent material, as shown in FIG. 2(b).

In the method for manufacturing the phosphorescent plate 100 according to this embodiment, since the method comprises a sprinkling step, the phosphorescent plate 100 having a sufficient amount of phosphorescent material is obtained.

Accordingly, in this case, a phosphorescent plate having more sufficiently improved phosphorescent properties is obtained.

In the sprinkling step, the phosphorescent material to be used is synonymous with the phosphorescent material in the above-described first liquid mixture.

Moreover, the phosphorescent material in the sprinkling step may be the same as or different from the phosphorescent material of the first liquid mixture or the phosphorescent material of the second liquid mixture, which will be described later, or the third liquid mixture, which will be described later.

In the sprinkling step, the amount of the phosphorescent material to be sprinkled is not particularly limited, but from the perspective of the strength of the phosphorescent layer 20, the phosphorescent material is preferably sprinkled in an amount which does not completely fill the spaces between the first dots.

Then, drying is carried out at a temperature of 30 to 100° C., whereby a first-dot layer 21 is formed.

(Coating Step)

The coating step is a step of firstly coating a surface of the first-dot layer 21 with a second liquid mixture containing a glass frit, a phosphorescent material, and a resin and forming a coating layer 22, as shown in FIG. 2(c).

In the method for manufacturing the phosphorescent plate 100 according to this embodiment, since the method comprises a coating step, the surface of the phosphorescent layer 20 formed is smooth.

As a result, second dots can be easily formed in the second-dot forming step in the second embodiment, which will be described later.

In the second liquid mixture, the glass frit is synonymous with the glass frit in the above-described first liquid mixture. Moreover, the same applies to the phosphorescent material and the resin.

The glass frit, phosphorescent material, and resin of the second liquid mixture may be the same as or different from the respectively corresponding glass frit, phosphorescent material, and resin of the first liquid mixture.

In the second liquid mixture, preferably, the mixing ratio of the glass frit is 20 to 50% by mass of the total mass of the second liquid mixture, the mixing ratio of the phosphorescent material is 20 to 50% by mass of the total mass of the second liquid mixture, and the mixing ratio of the resin is 20 to 50% by mass of the total mass of the second liquid mixture.

In this case, the glass fit can penetrate to the inside (the first-dot side) sufficiently.

The second liquid mixture may contain additives, such as viscosity modifiers, pH adjusters, preservatives, and fillers.

(First Firing Step)

The first firing step is a step of forming a phosphorescent layer 20 by firing the first-dot layer 21 and the coating layer 22.

As a result, as shown in FIG. 2(d), the phosphorescent layer 20 in which the first-dot layer 21 and the coating layer 22 are integral with each other is obtained.

The firing temperature is preferably 750 to 800° C.

When the firing temperature is below 750° C., sufficient firing tends to be not achieved, compared with the case where the firing temperature is within the above range, and, when the firing temperature is above 800° C., the luminance of the phosphorescent material tends to be low, compared with the case where the firing temperature is within the above range.

The phosphorescent plate 100 according to this embodiment has sufficiently improved phosphorescent properties since the phosphorescent layer 20 has a sufficient thickness, and has sufficient water resistance and chemical resistance since a glass frit is used in the phosphorescent layer 20.

(Image Layer Forming Step)

The image layer forming step is a step of forming an image layer 40 by coating a surface of the phosphorescent layer 20 with a printing liquid containing a glass frit and an inorganic pigment, as shown in FIG. 2(e).

Such an image layer forming step is not necessarily an essential step in the present invention.

In the method for manufacturing the phosphorescent plate 100 according to this embodiment, since the method comprises an image layer forming step, it is possible to express a predetermined character and/or pattern on the image layer 40 and illuminate these by means of a phosphorescent material.

Therefore, in this case, the phosphorescent plate 100 is suitably used as a phosphorescent guide sign for the purpose of conveying a message.

Examples of the inorganic pigment in the printing liquid are natural mineral pigments, such as carbon black, iron oxide, mercury sulfide, brown pigments, calcium carbonate, kaolin, and pearl pigments; synthetic inorganic pigments, such as zinc oxide, titanium dioxide, synthetic iron oxide red, cadmium yellow, nickel titanium yellow, strontium chromate, benzidine yellow, viridian, oxide of chromium, and synthetic ultramarine; ceramic pigments; and aluminum powders.

These inorganic pigments may be used alone, or a plurality of them may be used as a mixture.

The glass frit is synonymous with the glass frit in the above-described first liquid mixture. Moreover, the glass frit of the first liquid mixture or the second liquid mixture may be the same as or different from the glass frit of the printing liquid.

Examples of the method of applying the printing liquid to the phosphorescent layer 20 include screen printing, spraying, coating, and transfer.

The printing liquid may contain additives, such as viscosity modifiers, pH adjusters, preservatives, and fillers.

In this manner, the phosphorescent plate 100 according to this embodiment is obtained.

From the above, according to the method for manufacturing the phosphorescent plate 100 according to this embodiment, a phosphorescent plate 100 which generates phosphorescence having sufficient luminance and has improved phosphorescent properties is obtained.

This phosphorescent plate 100 is suitably used as a phosphorescent safety sign, such as an evacuation sign, a guide sign, a first-aid sign, or a danger/prohibition sign.

### Second Embodiment

Next, a second embodiment of the phosphorescent plate according to the present invention will be described. Constituent elements which are the same as or equivalent to those of the first embodiment are denoted by the same reference numerals, and their overlapping explanations are omitted.

FIG. 3 is a sectional view schematically showing a second embodiment of the phosphorescent plate according to the present invention.

As shown in FIG. 3, the phosphorescent plate 200 according to this embodiment comprises: a substrate 10; a phosphorescent layer 20 formed on one surface of the substrate 10 and containing a glass frit, a phosphorescent material, and a resin; dots 30 (hereinafter referred to as “second dots” for convenience) formed on a surface of the phosphorescent layer 20 and containing a glass frit, a phosphorescent material, and a resin; and an image layer 40 formed on a surface of the phosphorescent layer 20 in an area other than the second dots 30 and containing a glass frit and an inorganic pigment.

That is, the phosphorescent plate 200 according to this embodiment differs from the phosphorescent plate 100 according to the first embodiment in that the second dots 30 are formed on a surface of the phosphorescent layer 20.

In the second dots 30, preferably, the mixing ratio of the glass frit is 20 to 50% by mass of the total mass of the second dots 30, the mixing ratio of the phosphorescent material is 20 to 50% by mass of the total mass of the second dots 30, and the mixing ratio of the resin is 20 to 50% by mass of the total mass of the second dots 30.

In this case, sufficient luminance is generated and resistance to wear and soiling is achieved.

In the phosphorescent plate 200 according to this embodiment, since second dots 30 are formed on a surface of the phosphorescent layer 20, the second dots 30 exhibit a light-collecting effect and improve the luminance of the phosphorescence generated.

Therefore, such phosphorescent plate 200 has sufficient visibility even when installed in a dark place.

Moreover, the phosphorescent plate 200 also has excellent wear resistance since the second dots 30 are formed.

Accordingly, the phosphorescent plate 200 has an advantage that it is less slippery for those walking on the phosphorescent plate 200 when installed on a sidewalk as a phosphorescent guide sign.

For these reasons, according to the phosphorescent plate 200, phosphorescence having sufficient luminance is generated and phosphorescent properties are improved.

Further, since the phosphorescent plate 200 comprises an image layer 40, it is possible to express a predetermined character and/or pattern on the image layer 40 and illuminate these by means of a phosphorescent material. Therefore, in this case, the phosphorescent plate 200 is suitably used as a phosphorescent guide sign for the purpose of conveying a message.

The method for manufacturing the phosphorescent plate 200 according to the second embodiment will be described below.

FIGS. 4(a), (b), (c), (d) and (e) show a flow chart schematically showing manufacturing steps of the phosphorescent plate according to this embodiment.

Since the steps of (a) to (d) of FIG. 4 are the same as the steps of (a) to (d) of FIG. 2, explanations of these steps are omitted.

As shown in FIGS. 4(d) and (e), the method for manufacturing the phosphorescent plate 200 according to this embodiment comprises, after the above-described first firing step: an image layer forming step of forming an image layer 40 by coating a surface of the phosphorescent layer 20 with a printing liquid containing a glass frit and an inorganic pigment; a second-dot forming step of forming second dots 30 by applying a third liquid mixture containing a glass frit, a phosphorescent material, and a resin to a surface of the phosphorescent layer 20 in an area other than the image layer 40 in dot form; and a second firing step of firing the second dots 30.

(Second-Dot Forming Step)

The second-dot forming step is a step of forming second dots 30 by applying a third liquid mixture containing a glass frit, a phosphorescent material, and a resin to a surface of the phosphorescent layer 20 in an area other than the image layer 40 in dot form, as shown in FIG. 4(e).

From the perspective of the visibility of the image layer 40, preferably, the second dots 30 are not formed on the image layer 40.

In the method for manufacturing the phosphorescent plate 200 according to this embodiment, since the method comprises a second-dot forming step, the second dots 30 exhibit a light-collecting effect and a phosphorescent plate which generates phosphorescence having improved luminance is obtained. Moreover, since a glass frit is used in the second-dot forming step, the phosphorescent plate has sufficient water resistance and chemical resistance.

Therefore, a phosphorescent plate having sufficient visibility even when installed in a dark place is obtained.

Moreover, since the second dots 30 are formed by the second-dot forming step, a phosphorescent plate 200 also having excellent wear resistance is obtained.

Further, the obtained phosphorescent plate 200 has an advantage that it is less slippery for those walking on the phosphorescent plate when installed on a sidewalk as a phosphorescent guide sign.

In the third liquid mixture, the glass frit is synonymous with the glass frit of the above-described first liquid mixture. Moreover, the same applies to the phosphorescent material and the resin. Moreover, the glass frit of the first liquid mixture, the second liquid mixture, or the printing liquid may be the same as or different from the glass frit of the third liquid mixture; and the phosphorescent material and resin of the first liquid mixture or the second liquid mixture may be the same as or different from the respectively corresponding phosphorescent material and resin of the third liquid mixture.

In the second-dot forming step, the second dots 30 are preferably formed to have a thickness of 300 to 500 μm.

When the thickness is less than 300 the luminance of the phosphorescence tends to improve insufficiently, compared with the case where the thickness is in the above range, and, when the thickness is more than 500 μm, it tends to be difficult to remove soil in the case of soil adhesion, compared with the case where the thickness is in the above range.

In the second-dot forming step, the second dots 30 are preferably formed to have a diameter of 0.5 to 3.0 mm.

When the diameter is less than 0.5 mm or more than 3.0 mm, the luminance of the phosphorescence tends to improve insufficiently, compared with the case where the diameter is in the above range.

As described above, in the second-dot forming step, the second dots 30 are preferably formed to have a thickness of 300 to 500 μm.

In the third liquid mixture, preferably, the mixing ratio of the glass frit is 20 to 50% by mass of the total mass of the third liquid mixture, the mixing ratio of the phosphorescent material is 20 to 50% by mass of the total mass of the third liquid mixture, and the mixing ratio of the resin is 20 to 50% by mass of the total mass of the third liquid mixture.

In this case, sufficient luminance is generated and excellent strength and wear resistance are achieved.

Examples of the method of applying the third liquid mixture to the phosphorescent layer 20 include dot screen coating and dot transfer.

Of these, dot screen coating is preferable, and more preferably, the screen to be used has a thickness of 0.3 to 0.5 mm and a mesh size of 80 to 120.

The third liquid mixture may contain additives, such as viscosity modifiers, pH adjusters, preservatives, and fillers.

(Second Firing Step)

The second firing step is a step of firing the second dots 30. In firing of the second dots 30, the substrate 10 and the phosphorescent layer 20 may be fired again.

The firing temperature is preferably 750 to 800° C.

When the firing temperature is below 750° C., sufficient firing tends to be not achieved, compared with the case where the firing temperature is within the above range, and, when the firing temperature is above 800° C., the luminance of the phosphorescent material tends to be low, compared with the case where the firing temperature is within the above range.

In this manner, the phosphorescent plate 200 according to this embodiment is obtained.

From the above, according to the method for manufacturing the phosphorescent plate 200 according to this embodiment, a phosphorescent plate 200 which generates phosphorescence having sufficient luminance and has improved phosphorescent properties is obtained.

This phosphorescent plate 200 is suitably used as a phosphorescent safety sign, such as an evacuation sign, a guide sign, a first-aid sign, or a danger/prohibition sign.

### Third Embodiment

Next, a third embodiment of the phosphorescent plate according to the present invention will be described. Constituent elements which are the same as or equivalent to those of the first embodiment and the second embodiment are denoted by the same reference numerals, and their overlapping explanations are omitted.

FIG. 5 is a sectional view schematically showing a third embodiment of the phosphorescent plate according to the present invention.

As shown in FIG. 5, the phosphorescent plate 300 according to this embodiment comprises: a substrate 10; a phosphorescent layer 20 formed on one surface of the substrate 10 and containing a glass frit, a phosphorescent material, and a resin; second dots 30 formed on a surface of the phosphorescent layer 20 and containing a glass frit, a phosphorescent material, and a resin; an image layer 40 formed on a surface of the phosphorescent layer 20 in an area other than the second dots 30 and containing a glass frit and an inorganic pigment; and a surface layer 80 formed on surfaces of the second dots 30 and the image layer 40 and containing a glass frit.

That is, the phosphorescent plate 300 according to this embodiment differs from the phosphorescent plate 200 according to the second embodiment in that the surface layer 80 is formed on surfaces of the second dots 30.

The thickness of the surface layer 80 is not particularly limited as long as it is in a range which does not impair the phosphorescent properties of the phosphorescent plate 300.

Since the above surface layer 80 is provided on a surface so as to cover the second dots 30 and the image layer 40, the surface of the phosphorescent plate 300 is flat.

Accordingly, there is an advantage that the phosphorescent plate 300 is resistant to soiling since its surface has no irregularities, compared with the phosphorescent plate 200 according to the second embodiment.

For this reason, the phosphorescent plate 300 can be used for a long period of time and is resistant to soiling when installed on a sidewalk as a phosphorescent guide sign.

The method for manufacturing the phosphorescent plate 300 according to the third embodiment will be described below.

FIGS. 6(a), (b), (c), (d), (e) and (f) show a flow chart schematically showing manufacturing steps of the phosphorescent plate according to this embodiment.

Since the steps of (a) to (e) of FIG. 6 are the same as the steps of (a) to (e) of FIG. 4, explanations of these steps are omitted.

As shown in FIGS. 6(e) and (f), the method for manufacturing the phosphorescent plate 300 according to this embodiment comprises, after the above-described second firing step: a surface layer forming step of forming a surface layer 80 having a smooth surface by applying a treatment liquid containing a glass frit to surfaces of the second dots 30 and the image layer 40; and a third firing step of firing the surface layer.

(Surface Layer Forming Step)

The surface layer forming step is a step of forming a surface layer having a smooth surface by applying a treatment liquid containing a glass frit to surfaces of the second dots 30 and the image layer 40, as shown in FIG. 6(f).

In the method for manufacturing the phosphorescent plate 300 according to this embodiment, since the method comprises a surface layer forming step, the surface of the obtained phosphorescent plate 300 is smooth and resistant to soiling.

That is, the phosphorescent plate 300 obtained by the above method for manufacturing a phosphorescent plate is resistant to soiling even when installed and used for a long period of time on a sidewalk or the like as a phosphorescent guide sign.

In the treatment liquid, the glass frit to be used is not particularly limited as long as it does not impair the phosphorescent properties.

Such a glass frit is synonymous with the glass frit in the above-described first liquid mixture. Moreover, the glass frit of the first liquid mixture, the second liquid mixture, the third liquid mixture, or the printing liquid may be the same as or different from the glass frit contained in the treatment liquid.

Examples of the method of applying the treatment liquid to the second dots 30 and the phosphorescent layer 20 include screen printing, spraying, coating, and transfer.

The treatment liquid may contain additives, such as viscosity modifiers, pH adjusters, preservatives, and fillers.

(Third Firing Step)

The third firing step is a step of firing the surface layer 80. In firing of the surface layer 80, the substrate 10, the phosphorescent layer 20, and the second dots 30 may be fired again.

The firing temperature is preferably 750 to 800° C.

When the firing temperature is below 750° C., sufficient firing tends to be not achieved, compared with the case where the firing temperature is within the above range, and, when the firing temperature is above 800° C., the luminance of the phosphorescent material tends to be low, compared with the case where the firing temperature is within the above range.

In this manner, the phosphorescent plate 300 according to this embodiment is obtained.

From the above, according to the method for manufacturing the phosphorescent plate 300 according to this embodiment, a phosphorescent plate 300 which generates phosphorescence having sufficient luminance and has improved phosphorescent properties is obtained.

This phosphorescent plate 300 is suitably used as a phosphorescent safety sign, such as an evacuation sign, a guide sign, a first-aid sign, or a danger/prohibition sign.

### Fourth Embodiment

Next, a fourth embodiment of the phosphorescent plate according to the present invention will be described. Constituent elements which are the same as or equivalent to those of the first embodiment, the second embodiment, and the third embodiment are denoted by the same reference numerals, and their overlapping explanations are omitted.

FIG. 7 is a sectional view schematically showing a fourth embodiment of the phosphorescent plate according to the present invention.

As shown in FIG. 7, the phosphorescent plate 400 according to this embodiment comprises: a substrate 11 comprising a steel plate 1 and glaze layers 2 comprising an enamel glaze formed on both surfaces of the steel plate 1; a phosphorescent layer 20 formed on one surface of the substrate 11; second dots 30, which are dots formed on a surface of the phosphorescent layer 20; and an image layer 40 on a surface of the phosphorescent layer 20; and has a fitting device 50 mounted on a surface of the substrate 11 opposite from the phosphorescent layer 20.

That is, the phosphorescent plate 400 according to this embodiment differs from the phosphorescent plate 300 according to the third embodiment in that the substrate 11 comprises a steel plate 1 and glaze layers 2 comprising an enamel glaze formed on both surfaces of the steel plate 1 and that a fitting device 50 is mounted on a surface of the substrate 11 opposite from the phosphorescent layer 20.

The method for manufacturing the phosphorescent plate 400 according to the fourth embodiment will be described below.

FIGS. 8(a) and (b) show a flow chart schematically showing manufacturing steps of the substrate in the phosphorescent plate according to this embodiment.

As shown in FIGS. 8(a) and (b), the manufacturing steps of the phosphorescent plate 400 according to this embodiment further comprises a blasting step for manufacturing the substrate 11 and a substrate forming step.

That is, the method for manufacturing the phosphorescent plate 400 according to this embodiment comprises: a blasting step of blasting at least one surface of a steel plate 1 and converting the surface into a rough surface; a substrate forming step of providing a substrate 11 by applying an enamel glaze containing a white pigment to the rough surface and firing the enamel glaze; a first-dot forming step of forming first dots by applying a first liquid mixture containing a glass frit, a phosphorescent material, and a resin to one surface of the substrate 11 in dot form; a sprinkling step of forming a first-dot layer 21 by sprinkling a phosphorescent material on surfaces of the first dots and drying the phosphorescent material; a coating step of coating a surface of the first-dot layer 21 with a second liquid mixture containing a glass frit, a phosphorescent material, and a resin and forming a coating layer 22; a first firing step of forming a phosphorescent layer 20 by firing the first-dot layer 21 and the coating layer 22; an image layer forming step of forming an image layer 40 by coating a surface of the phosphorescent layer 20 with a printing liquid containing a glass frit and an inorganic pigment; a second-dot forming step of forming second dots 30 by applying a third liquid mixture containing a glass frit, a phosphorescent material, and a resin to a surface of the phosphorescent layer 20 in an area other than the image layer 40 in dot form; a second firing step of firing the second dots 30; and a mounting step of mounting a fitting device 50 on a surface of the substrate 11 opposite from the phosphorescent layer 20.

(Blasting Step)

The blasting step is a step of blasting a surface of the steel plate 1 and converting the surface into a rough surface, as shown in FIG. 8(a).

Carrying out blasting improves the adhesion between the steel plate 1 and the enamel glaze.

Examples of the steel plate 1 include iron plates, stainless-steel plates, aluminum plates, and ceramic plates.

Of these, the steel plate 1 is preferably a stainless-steel plate.

Such a stainless-steel plate may contain silicon, molybdenum, phosphorus, sulfur, chromium, niobium, tantalum, and the like.

In this case, more excellent water resistance and chemical resistance are achieved.

The steel plate 1 is preferably formed into a bow-shape in advance. Specifically, the steel plate 1 is preferably concaved toward the side opposite from the side on which the phosphorescent layer 20 will be formed later.

In this case, possible distortion of the phosphorescent plate 400 due to expansion of the enamel glaze, the glass frit, or the resin in the subsequent firing can be suppressed.

Blasting is carried out using an air blasting apparatus, a sand blasting apparatus, a micro-blasting apparatus, a shot blasting apparatus, or the like.

The above-described steel plate 1 may be formed into a bow-shape by such blasting. That is, one surface side of the steel plate 1 may be processed more strongly than the other surface side and the steel plate 1 may be formed into a bow-shape.

(Substrate Forming Step)

The substrate forming step is a step of providing a substrate 11 by applying an enamel glaze containing a white pigment to the rough surface and firing the enamel glaze, as shown in FIG. 8(b).

Application of an enamel glaze to the steel plate 1 provides more excellent water resistance and chemical resistance and also allows a long-term use.

Here, the term “enamel glaze” refers to a glaze mainly composed of a glass frit for coating a surface of a metal, such as iron, and being baked on it. In this embodiment, such an enamel glaze used may be any publicly known one.

Examples of the method of applying the enamel glaze to the steel plate 1 include screen printing, spraying, coating, transfer, and impregnation.

Then, firing is carried out at a temperature of 750 to 850° C., whereby the substrate 11 is obtained.

This substrate 11 is subjected to a first-dot forming step, a sprinkling step, a coating step, and a second-dot forming step in the same manner as with the above-described phosphorescent plate 200 according to the second embodiment.

(Mounting Step)

The mounting step is a step of mounting a fitting device 50 on a surface of the substrate 11 opposite from the phosphorescent layer 20.

The phosphorescent plate 400 according to this embodiment can be easily installed on the ground, a wall, or the like through the fitting device 50 since it comprises a mounting step.

Such fitting device 50 comprises: a thread portion 5 mounted on a surface of the substrate 11 opposite from the phosphorescent layer 20; and a cap portion 6 screwed into the thread portion 5, the cap portion 6 being provided with a groove portion 6a on its side surface.

When the phosphorescent plate 400 according to this embodiment is to be installed on the ground, a wall, or the like, a predetermined hole is provided on the ground or the wall, and a fitting device 50 in which the cap portion 6 has an adhesive applied to its outer surface is fitted into the hole. As a result, the phosphorescent plate 400 is installed.

At this time, since the cap portion 6 has a groove portion 6a, the phosphorescent plate 400 is installed more strongly.

The thread portion 5 may be mounted on the steel plate 1 in advance, in an intermediate manufacturing process, or lastly.

While preferred embodiments of the present invention have been described above, the present invention is not limited to the above-described embodiments.

For example, it is not essential to provide the image layer 40 in the phosphorescent plates according to the first to fourth embodiments.

In the first to fourth embodiments, the first, second, and third firing steps may be carried out independently or simultaneously.

That is, the second firing step may also serve as the first firing step, and the third firing step may also serve as the first firing step and/or the second firing step.

In the phosphorescent plate 100 according to the first embodiment, a surface layer may be formed by applying a treatment liquid containing a glass frit to a surface of the phosphorescent layer 20.

In the phosphorescent plate 400 according to the fourth embodiment, when the steel plate 1 is to be blasted, only one surface may be blasted, and the enamel glaze may be applied to only one surface.

In the phosphorescent plate 200 according to the second embodiment, the thread portion 5 and the cap portion 6 may be integral with each other.

### Examples

While the present invention will be described more specifically below by way of Examples, the present invention is not limited to these Examples.

### Example 1

By carrying out the following steps, a phosphorescent plate was prepared.

### [Blasting Step and Substrate Forming Step]

Both surfaces of a stainless-steel plate containing molybdenum (steel plate, product name: SUS316J1L, manufactured by Nippon Metal Industry Co., Ltd.) were subjected to alumina shot blasting using a shot blasting apparatus. At this time, the distance between the nozzle and the stainless-steel plate in the alumina shot blasting of one surface side was made to be 20 cm, and the distance between the nozzle and the stainless-steel plate in the alumina shot blasting of the other surface side was made to be 30 cm, whereby the stainless-steel plate was formed into a bow-shape.

Then, an enamel glaze comprising 90% of a titanium oxide powder and 10% of a glass frit was applied to both surfaces of the obtained stainless-steel plate and fired at 800° C., whereby a substrate was obtained.

[First-Dot Layer Forming Step and Sprinkling Step]

A first liquid mixture containing 10 g of a glass frit (product name: 21707, manufactured by Tokan Material Technology Co., Ltd.), 5 g of an inorganic phosphorescent material (product name: N-Yako, manufactured by Nemoto & Co., Ltd.), and 5 g of an acrylic resin (product name: OS-4521-C, manufactured by Goo Chemical Co., Ltd.) was applied to a concave surface of the obtained bow-shaped substrate in dot form by dot screen printing using a 100-mesh plate.

Then, 30 g of the inorganic phosphorescent material was sprinkled from above the dots and fired at 750° C., whereby a first-dot layer was prepared.

[Coating Step]

Then, a second liquid mixture containing 10 g of the glass frit, 5 g of the inorganic phosphorescent material, and 5 g of the acrylic resin was applied to a surface of the first-dot layer by screen printing using a 100-mesh plate, whereby a coating layer was prepared.

[First Firing Step]

The substrate having the coating layer and the first-dot layer formed thereon, obtained in this manner, was fired at 800° C., whereby a phosphorescent layer was formed and a phosphorescent plate was obtained. The thickness of the obtained phosphorescent layer was 600

### Example 2

By carrying out the following steps in addition to the steps of Example 1, a phosphorescent plate was prepared.

[Second-Dot Forming Step]

A third liquid mixture containing 10 g of a glass frit, 5 g of an inorganic phosphorescent material, and 5 g of an acrylic resin was applied to a surface of the phosphorescent layer in dot form by dot screen printing using a 100-mesh plate, whereby second dots were prepared.

[Second Firing Step]

Then, lastly, firing was carried out at 800° C., whereby a phosphorescent plate was obtained.

### Example 3

By carrying out the following steps in addition to the steps of Example 2, a phosphorescent plate was prepared.

[Surface Layer Forming Step]

A treatment liquid containing 5 g of a glass frit was applied to surfaces of the second dots by screen printing using a 100-mesh plate so as to obtain a smooth surface.

[Third Firing Step]

Then, lastly, firing was carried out at 800° C., whereby a phosphorescent plate was obtained.

### Example 4

A phosphorescent plate was obtained in the same manner as in Example 2 except that the thickness of the phosphorescent layer was made to be 900 μm.

### Example 5

A phosphorescent plate was obtained in the same manner as in Example 2 except that the thickness of the phosphorescent layer was made to be 1200 μm.

(Evaluation Method)

[Phosphorescence Luminance Test 1]

A phosphorescence luminance test in compliance with JIS-Z-9107 was carried out using the phosphorescent plates of Examples 1 to 3.

First, the phosphorescent plates of Examples 1 to 3 were stored in a dark place for 3 hours or more, being shielded from external light, using a light evaluation system TL-1 (manufactured by TECHNOS Co., Ltd.). Then, they were irradiated for 20 minutes with a fluorescent lamp as a simulator of CIE standard illuminant D₆₅ at an illuminance of 100 lux (lx), and, after the irradiation was stopped, a luminance measurement was carried out for 20 minutes.

The obtained results are shown in Table 1.

[Phosphorescence Luminance Test 2]

A phosphorescence luminance test in compliance with JIS-Z-9107 was carried out using the phosphorescent plates of Examples 2, 4 and 5.

First, the phosphorescent plates of Examples 2, 4 and 5 were stored in a dark place for 3 hours or more, being shielded from external light, using a light evaluation system TL-1 (manufactured by TECHNOS Co., Ltd.). Then, they were irradiated for 20 minutes with a fluorescent lamp as a simulator of CIE standard illuminant D₆₅ at an illuminance of 200 lux (lx), and, after the irradiation was stopped, a luminance measurement was carried out for 60 minutes.

The obtained results are shown in Table 2.

[Phosphorescence Luminance Test 3]

A phosphorescence luminance test in compliance with JIS-Z-9107 was carried out using the phosphorescent plates of Examples 2, 4 and 5.

First, the phosphorescent plates of Examples 2, 4 and 5 were stored in a dark place for 3 hours or more, being shielded from external light, using a light evaluation system TL-1 (manufactured by TECHNOS Co., Ltd.). Then, they were irradiated for 20 minutes with a fluorescent lamp as a simulator of CIE standard illuminant D₆₅ at an illuminance of 100 lux (lx), and, after the irradiation was stopped, a luminance measurement was carried out for 60 minutes.

The obtained results are shown in Table 3.

TABLE 1

| Measurement time | | | |
|---|---|---|---|
| (minutes) | Example 1 | Example 2 | Example 3 |
| 0.5 | 1323 | 1688 | 1548 |
| 1.0 | 1098 | 1283 | 1248 |
| 1.5 | 927 | 1081 | 1062 |
| 2.0 | 812 | 948 | 936 |
| 2.5 | 725 | 850 | 822 |
| 3.0 | 654 | 771 | 746 |
| 3.5 | 600 | 701 | 678 |
| 4.0 | 556 | 649 | 623 |
| 4.5 | 514 | 599 | 573 |
| 5.0 | 478 | 564 | 540 |
| 10 | 285 | 335 | 326 |
| 15 | 202 | 235 | 223 |
| 20 | 157 | 175 | 170 |

TABLE 2

| Measurement time | | | |
|---|---|---|---|
| (minutes) | Example 2 | Example 4 | Example 5 |
| 0.5 | 2163.0 | 2008.0 | 2069.0 |
| 1.0 | 1666.0 | 1554.0 | 1623.0 |
| 1.5 | 1315.0 | 1252.0 | 1317.0 |
| 2.0 | 1095.0 | 1046.0 | 1111.0 |
| 2.5 | 939.1 | 903.3 | 967.8 |
| 3.0 | 816.2 | 795.9 | 854.3 |
| 3.5 | 725.5 | 707.6 | 765.9 |
| 4.0 | 649.1 | 640.8 | 694.2 |
| 4.5 | 589.5 | 582.3 | 633.2 |
| 5.0 | 539.4 | 534.6 | 584.2 |
| 10 | 285.2 | 288.8 | 321.4 |
| 15 | 187.4 | 192.7 | 216.2 |
| 20 | 137.5 | 142.3 | 160.1 |
| 25 | 106.6 | 110.7 | 125.0 |
| 30 | 86.0 | 89.6 | 101.2 |
| 35 | 71.0 | 74.6 | 84.9 |
| 40 | 60.3 | 63.9 | 72.7 |
| 45 | 52.3 | 55.2 | 62.6 |
| 50 | 45.4 | 48.1 | 55.3 |
| 55 | 40.5 | 42.7 | 49.2 |
| 60 | 36.5 | 38.4 | 44.3 |

TABLE 3

| Measurement time | | | |
|---|---|---|---|
| (minutes) | Example 2 | Example 4 | Example 5 |
| 0.5 | 1284.0 | 1315.0 | 1516.0 |
| 1.0 | 1028.0 | 1039.0 | 1210.0 |
| 1.5 | 862.6 | 879.4 | 998.5 |
| 2.0 | 733.0 | 742.1 | 854.7 |
| 2.5 | 643.3 | 653.4 | 744.0 |
| 3.0 | 573.1 | 586.3 | 659.3 |
| 3.5 | 517.3 | 529.8 | 591.0 |
| 4.0 | 472.5 | 485.0 | 536.8 |
| 4.5 | 432.5 | 447.4 | 492.1 |
| 5.0 | 399.8 | 414.4 | 452.1 |
| 10 | 223.1 | 239.0 | 249.6 |
| 15 | 152.1 | 163.6 | 166.3 |
| 20 | 112.3 | 123.0 | 123.0 |
| 25 | 88.43 | 97.33 | 94.98 |
| 30 | 71.86 | 79.70 | 76.41 |
| 35 | 60.00 | 66.77 | 63.36 |
| 40 | 51.29 | 56.89 | 53.48 |
| 45 | 44.64 | 49.96 | 46.20 |
| 50 | 39.32 | 44.08 | 40.44 |
| 55 | 34.96 | 39.26 | 35.50 |
| 60 | 31.09 | 35.50 | 31.86 |

As apparent from the results shown in Tables 1, 2 and 3, it was confirmed that, according to the phosphorescent plate of the present invention, phosphorescence having sufficient luminance is generated and phosphorescent properties can be also improved.

The phosphorescent plate of Example 1 corresponds to Grade A₁₀₀ in accordance with the testing and acceptance criteria for high-luminance phosphorescent guide signs stipulated in Notification No. 2 by the Fire and Disaster Management Agency in 1999.

### INDUSTRIAL APPLICABILITY

According to the method for manufacturing the phosphorescent plate of the present invention, a phosphorescent plate which generates phosphorescence having sufficient luminance and has sufficiently improved phosphorescent properties is obtained.

Such a phosphorescent plate can be installed and used for a long period of time on a sidewalk or the like as a phosphorescent guide sign.

### BRIEF DESCRIPTION OF DRAWINGS

FIG. 1 is a sectional view schematically showing a first embodiment of the phosphorescent plate according to the present invention.

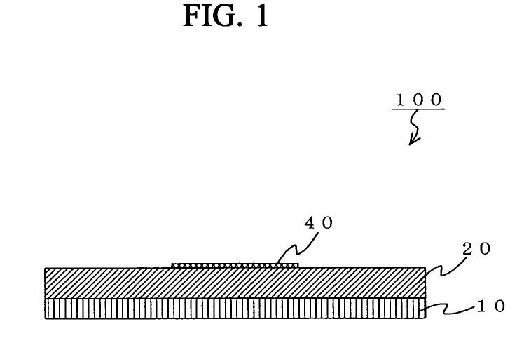

FIGS. 2(a), (b), (c), (d) and (e) show a flow chart schematically showing manufacturing steps of the phosphorescent plate according to this embodiment.

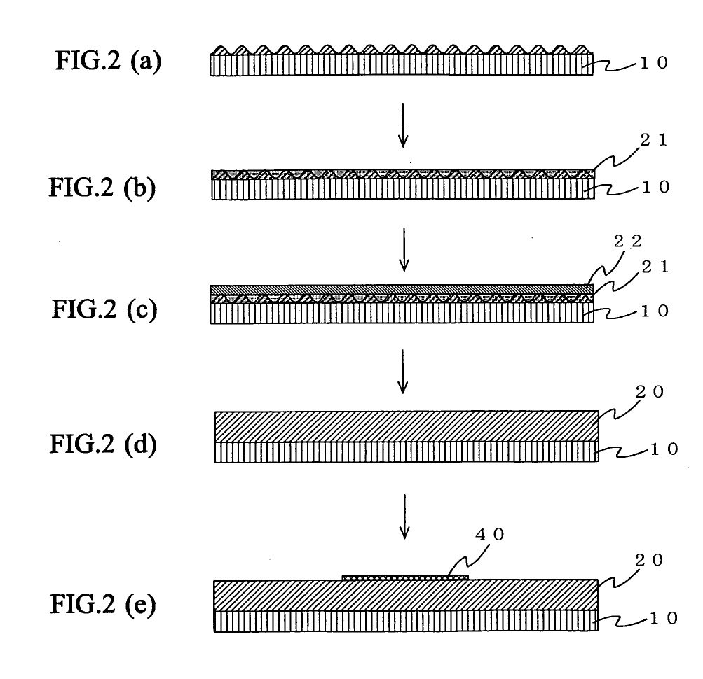

FIG. 3 is a sectional view schematically showing a second embodiment of the phosphorescent plate according to the present invention.

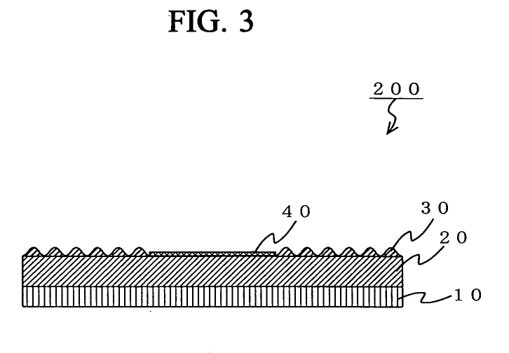

FIGS. 4(a), (b), (c), (d) and (e) show a flow chart schematically showing manufacturing steps of the phosphorescent plate according to this embodiment.

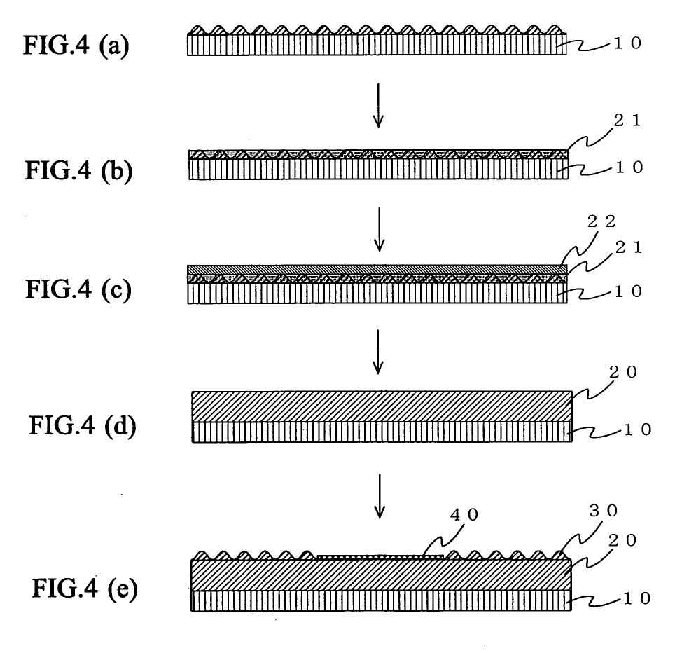

FIG. 5 is a sectional view schematically showing a third embodiment of the phosphorescent plate according to the present invention.

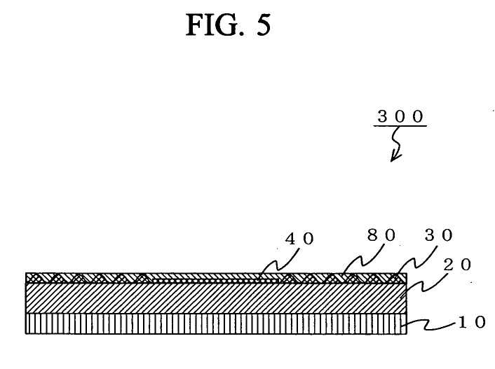

FIGS. 6(a), (b), (c), (d), (e) and (f) show a flow chart schematically showing manufacturing steps of the phosphorescent plate according to this embodiment.

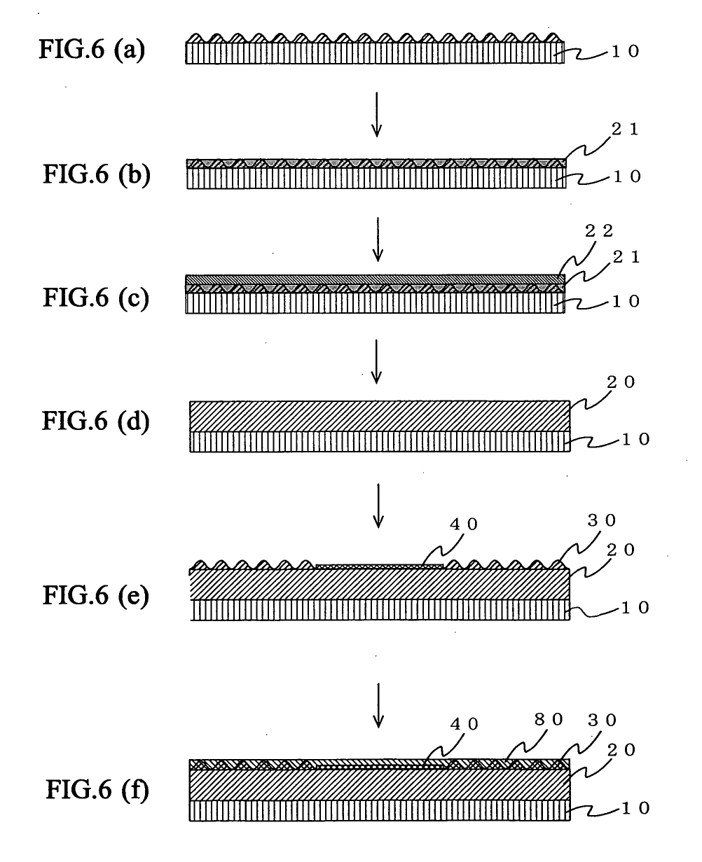

FIG. 7 is a sectional view schematically showing a fourth embodiment of the phosphorescent plate according to the present invention.

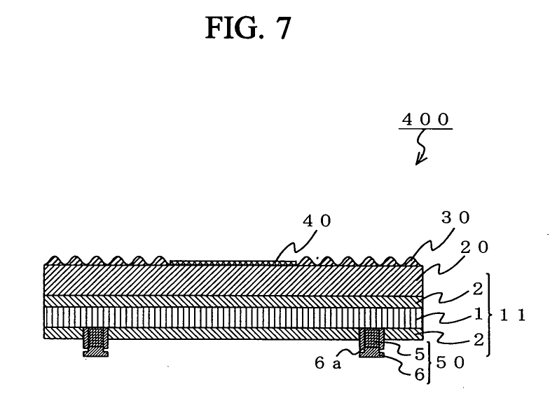

FIGS. 8(a) and (b) show a flow chart schematically showing manufacturing steps of the substrate in the phosphorescent plate according to this embodiment.

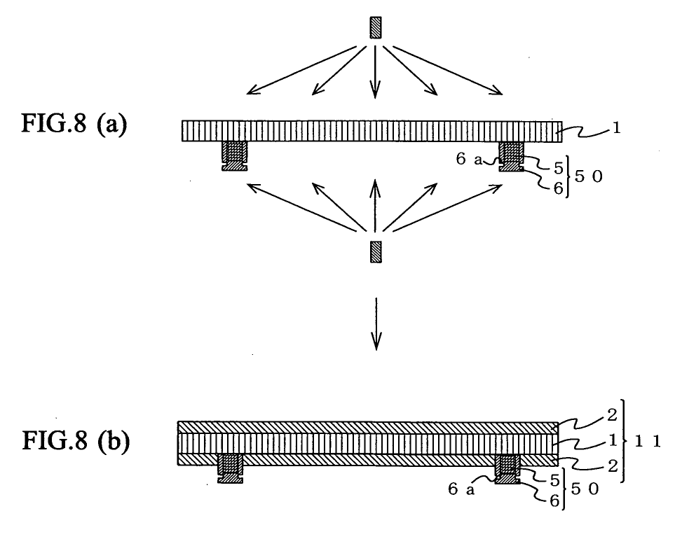

### EXPLANATION OF REFERENCE NUMERALS

1 steel plate

2 glaze layer

5 thread portion

6 cap portion

6a groove portion

10, 11 substrate

20 phosphorescent layer

21 first-dot layer

22 coating layer

30 second dots

40 image layer

50 fitting device

80 surface layer

100, 200, 300, 400 phosphorescent plate

1. A method for manufacturing a phosphorescent plate, characterized by comprising:
a first-dot forming step of forming first dots by applying a first liquid mixture containing a glass frit, a phosphorescent material, and a resin to one surface of a substrate in dot form;
a sprinkling step of forming a first-dot layer by sprinkling a phosphorescent material on surfaces of the first dots and drying the phosphorescent material;
a coating step of coating a surface of the first-dot layer with a second liquid mixture containing a glass frit, a phosphorescent material, and a resin and forming a coating layer; and
a first firing step of forming a phosphorescent layer by firing the first-dot layer and the coating layer.

2. The method for manufacturing a phosphorescent plate according to claim 1, characterized by further comprising:
a second-dot forming step of forming second dots by applying a third liquid mixture containing a glass frit, a phosphorescent material, and a resin to a surface of the phosphorescent layer in dot form; and
a second firing step of firing the second dots.

3. The method for manufacturing a phosphorescent plate according to claim 1, characterized by further comprising: an image layer forming step of forming an image layer by coating a surface of the phosphorescent layer with a printing liquid containing a glass frit and an inorganic pigment.

4. The method for manufacturing a phosphorescent plate according to claim 2, characterized by further comprising:
a surface layer forming step of forming a surface layer having a smooth surface by applying a treatment liquid containing a glass frit to surfaces of the second dots; and
a third firing step of firing the surface layer.

5. The method for manufacturing a phosphorescent plate according to claim 1, characterized by further comprising, prior to the first-dot forming step:
a blasting step of blasting at least one surface of a steel plate and converting said surface into a rough surface; and
a substrate forming step of providing a substrate by applying an enamel glaze containing a white pigment to the rough surface and firing the enamel glaze.

6. A phosphorescent plate obtained by a manufacturing method according to claim 1.

7. A phosphorescent plate, characterized by comprising: a substrate;
a phosphorescent layer formed on one surface of said substrate and containing a glass frit, a phosphorescent material, and a resin; and
dots formed on a surface of said phosphorescent layer and containing a glass frit, a phosphorescent material, and a resin.

8. The phosphorescent plate according to claim 7, characterized by further comprising: an image layer formed on a surface of the phosphorescent layer in an area other than the dots and containing a glass frit and an inorganic pigment.

9. The phosphorescent plate according to claim 7, characterized by further comprising: a surface layer formed on surfaces of the dots and containing a glass frit.

10. The phosphorescent plate according to claim 7, characterized in that the substrate comprises: a steel plate;
and a glaze layer comprising an enamel glaze formed on at least one side of said steel plate.

11. The phosphorescent plate according to claim 7, characterized in that a fitting device is mounted on a surface of the substrate opposite from the phosphorescent layer.
